(19) United States
(12) Patent Application Publication
(10) Pub. No.: US 2026/0321277 A1
(43) Pub. Date: Oct. 15, 2026

(54) REAL-TIME SOURCE-WISE ENERGY ESTIMATION SYSTEM

(71) Applicant: Audioshake, Inc., San Francisco, CA (US)

(72) Inventors: Fabian-Robert Stöter, Oberursel (DE); Jessica Powell, San Francisco, CA (US)

(73) Assignee: Audioshake, Inc., San Francisco, CA (US)

(21) Appl. No.: 19/641,255

(22) Filed: Apr. 7, 2026

Related U.S. Application Data
(60) Provisional application No. 63/786,246, filed on Apr. 9, 2025.

(51) Int. Cl. G10L 25/21; G10L 25/18; G10L 25/30

(52) U.S. Cl. CPC G10L 25/21; G10L 25/18; G10L 25/30

(57) ABSTRACT

A method, system, and computer-readable medium for generating energy estimations for a plurality of component sources from a single input signal. A machine learning model processes the input signal, or a representation thereof, to generate per-source energy estimates without performing source separation. The model may output energy values directly or via intermediate representations. The techniques enable low-latency, real-time estimation of component source energy from a mixture signal.

### CROSS-REFERENCE TO RELATED APPLICATIONS

This application claims the benefit of prior application U.S. Provisional Application No. 63/786,246, filed Apr. 9, 2025, titled “Real-Time Source-Wise Energy Estimation System,” which is herein incorporated by reference in its entirety for all purposes.

### TECHNICAL FIELD

Aspects of the present disclosure relate generally to computer systems, and more particularly, to signal processing.

### BACKGROUND

The transformation of signals into energy output is a fundamental process across various fields, including electronics, biomedical engineering, and renewable energy systems. This process involves converting an input signal-such as audio, light, electrical, mechanical, thermal, or biochemical stimuli-into usable energy forms, typically electrical or mechanical power. Understanding the mechanisms and technologies underlying this transformation is essential for optimizing energy efficiency and system performance.

Transforming signals into energy output has widespread applications in diverse domains. For instance, in renewable energy systems, photovoltaic cells convert solar signals (light) into electrical energy, and wind turbines convert kinetic energy from wind into mechanical and electrical power. Similarly, in biomedical devices, bioelectric signals generated by physiological processes can power implantable sensors and prosthetic devices.

One application of transforming signals into energy output involves audio signals. For example, audio source separation is the task of separating a mixture of sounds into its original components. In the past a number of different deep learning based systems have been proposed that directly learn the mapping from the mixture of the separated sound source. While traditional systems focus on making these separated components audible, many real-world applications only need a quick measure of each source's energy rather than a fully isolated waveform. Examples include visual indicators (e.g., VU meters) or real-time stage lighting control, both of which demand minimal latency (under 10 ms) and modest computing resources. Existing separation methods, such as full waveform separation, often introduce delays or complexity that exceed these constraints.

Existing approaches for analyzing multi-source signals generally fall into two categories: source separation and event-based detection. Source separation techniques attempt to reconstruct individual component signals from a mixture. While effective for producing isolated audio tracks, these approaches are computationally expensive and introduce latency that is incompatible with real-time applications.

Event-based detection techniques, on the other hand, identify discrete occurrences of particular sound events, such as onsets or peaks. While these methods are efficient, they do not provide continuous information about the magnitude or intensity of each component source over time. Importantly, neither source separation nor event-based detection techniques are designed to directly estimate the continuous energy levels of multiple component sources within a mixture signal. Estimating energy differs fundamentally from reconstructing signals or detecting events, as it requires quantifying the relative contribution of each source at fine temporal resolution without necessarily recovering the underlying waveform. Thus, there is a need for improved methods and systems that sidestep full waveform separation and directly predict the energy of each source, thereby delivering real-time accuracy while reducing computational overhead and latency.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In some embodiments, the energy estimations are generated directly by a trained machine learning model without explicitly separating the input signal into individual component source waveforms. The model may output energy values directly or may generate intermediate representations, such as masks, that are applied to a representation of the input signal.

In various embodiments, the input signal may be processed in the time domain or transformed into a time-frequency representation using techniques such as Short-Time Fourier Transform (STFT), mel-frequency transforms, wavelet transforms, or learned representations.

In some embodiments, the energy estimation corresponds to a quantitative measure of signal magnitude, intensity, or perceived loudness, and may be computed using one or more energy functions.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The disclosure may best be understood by reference to the following description taken in conjunction with the accompanying drawings, which illustrate particular embodiments of the present disclosure. In the description that follows, like parts are marked throughout the specification and drawings with the same numerals, respectively. The drawing figures are not necessarily drawn to scale and certain figures may be shown in exaggerated or generalized form in the interest of clarity and conciseness.

FIG. 1 is a representative view of an example audio file decomposed into energy estimates for component parts, in accordance with embodiments of the present disclosure.

FIG. 2 illustrates an example inputs and outputs for a model, in accordance with embodiments of the present disclosure.

FIG. 3 illustrates an example model architecture, in accordance with embodiments of the present disclosure.

FIG. 4 illustrates one example method for training a model, in accordance with embodiments of the present disclosure.

FIG. 5 illustrates a block diagram of an example instantaneous stem-wise energy prediction system, in accordance with embodiments of the present disclosure.

FIG. 6 illustrates an example graphical representation of energy estimation outputs, in accordance with embodiments of the present disclosure.

FIG. 7 illustrates an example method for generating energy estimations of a plurality of component sources from a single input signal, in accordance with embodiments of the present disclosure.

FIG. 8 illustrates an example method for generating energy estimations of a plurality of component sources from an input signal using a machine learning model without performing source separation, in accordance with embodiments of the present disclosure.

FIG. 9 illustrates one example of a system, in accordance with embodiments of the present disclosure.

### DETAILED DESCRIPTION

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular interlocking parts. However, it should be noted that the techniques of the present disclosure apply to various other parts. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of wires, circuits, bridges and other features or elements may reside between the processor and memory. Consequently, a connection does not necessarily mean a direct, unimpeded connection unless otherwise noted. As used herein, the term “convolution” and “convolutional” will be used interchangeably.

As mentioned above, there is a need for improved methods and systems that sidestep full waveform separation and directly predict the energy of each source, thereby delivering real-time accuracy while reducing computational overhead and latency. In some embodiments, energy estimation represents the “loudness” of each source. With current technology, there have been several different attempts for solving this problem. For example, many existing systems treat audio source detection as a binary classification task: Does a particular source (e.g., speech, noise, guitar) exist in a short segment of audio or not? These methods operate on fixed-length frames (often tens or hundreds of milliseconds long). They also often label each frame with a simple on/off indicator for each source. In addition, they commonly reduce the problem to classification rather than accurately estimate how much of that source is present (i.e., its instantaneous energy). While these systems work adequately in certain applications (like voice activity detection in telephony), they do not track the continuous energy levels of each source in real time.

As another example, more advanced methods attempt to separate an audio mixture into individual sources before detection. Separation can help isolate each source for further processing (e.g., haptic feedback, mixing, or remixing), but full-fledged source separation pipelines typically require significant computational resources. However, this introduces additional latency, especially if neural-network-based separation is used. For instance, recent music source separation models—pushing toward state-of-the-art performance—can add around 23 ms of latency, and even then, the audio quality may be lower than desired for certain applications.

Many real-world systems impose strict constraints on computational complexity, latency, and power consumption. For example, applications such as live audio processing, augmented reality (AR), virtual reality (VR), and mobile or wearable devices require near-instantaneous processing with minimal delay. Existing source separation systems, particularly those based on deep learning, often introduce latency on the order of tens of milliseconds or more, which can degrade user experience in interactive environments.

Furthermore, many machine learning models for audio analysis are designed to output either reconstructed signals or classification labels, rather than continuous energy estimates. Adapting such models to provide accurate, low-latency energy estimation for multiple sources remains challenging due to the trade-offs between model complexity, accuracy, and responsiveness.

As another example, there are even several patents that focus on analyzing audio signals for events (e.g., drum hits, melody changes, vocal onsets) and mapping those events to haptic feedback. Examples include US20230057082 (Sony) and US20220076687 (Sony). These patents describe methods to decompose the audio signal into frequency bands and detect amplitude peaks or shifts in frequency content. In these methods, identified events (e.g., strong percussive hits) are mapped to vibrations or pulses. Haptic generation is optimized by limiting the number of events and tuning intensity/duration of each haptic pulse. Other patent examples include U.S. Pat. No. 10,055,950B2 (Immersion) and U.S. Pat. No. 8,688,251B2 (Immersion), which disclose techniques for generating haptic signals that correspond to significant audio cues. These systems emphasize preventing sensory overload, adjusting haptic intensity, and synchronizing feedback with audio events. These patents do not simply convert the waveform into vibrations; instead, they detect meaningful points (e.g., drum beats) and use them as triggers.

While effective for interactive media (games, VR/AR experiences, music visualization), these event-based methods are not primarily concerned with continuous energy-level prediction or ultra-low-latency operation across multiple distinct sources. Accordingly, there remains a need for improved methods and systems that can estimate the energy of multiple component sources directly from a mixture signal, without performing source separation, while maintaining low computational overhead and enabling real-time or near real-time operation.

The disclosed techniques provide a technical improvement over conventional signal processing systems by enabling estimation of per-source energy directly from a mixture signal without requiring computationally intensive source separation. This reduces processing latency and computational overhead, thereby improving the performance of real-time signal processing systems.

In some embodiments, the disclosed techniques are integrated into real-time systems, including audio processing pipelines, augmented reality (AR) systems, virtual reality (VR) systems, and interactive media platforms, where low-latency processing is critical for system performance.

In some embodiments, the system is implemented on hardware devices, including mobile devices, wearable devices, embedded systems, or dedicated audio processing hardware, and operates under constraints of limited processing power and strict latency requirements.

In some embodiments, the generated energy estimates are used to control external systems, including visual displays, lighting systems, haptic feedback devices, or audio mixing systems, thereby producing tangible effects based on the processed signal.

Unlike purely mathematical operations performed in isolation, the disclosed techniques operate on real-world signals and are designed to meet practical constraints of latency, computational efficiency, and system integration. The methods therefore provide a technological solution to a technical problem in signal processing.

The input audio signal represents a physical signal captured from the environment, and the processing performed by the system transforms the signal into a different representation that reflects the energy contributions of underlying sources. This transformation enables downstream physical or perceptual effects, such as audio rendering, visualization, or haptic feedback.

In some embodiments, the methods described herein improve the functioning of computer systems by enabling efficient processing of multi-source signals using reduced computational resources while maintaining accuracy. By avoiding reconstruction of individual source waveforms, the system reduces memory usage, processing time, and power consumption.

In some embodiments, the systems and methods described herein are not limited to any particular signal representation, energy function, or model output structure. More generally, the disclosed techniques provide a mapping from an input signal comprising a mixture of component sources directly to one or more energy estimates corresponding to the component sources, without requiring reconstruction or explicit separation of the component source signals. While many embodiments relate to audio signals, the disclosed techniques may be applied to other types of signals, including biomedical signals, vibration signals, electromagnetic signals, or other time-series data.

In various embodiments, the mapping may be implemented using any suitable machine learning model, including neural networks, statistical models, or hybrid systems, and may operate on raw time-domain signals, time-frequency representations, or other derived feature representations.

In some embodiments, the model outputs energy estimates directly. In other embodiments, the model outputs intermediate representations, such as masks or weights, that are applied to a representation of the input signal to derive energy estimates.

The techniques and mechanisms of the present disclosure describe methods and systems for continuous, instantaneous energy estimation. According to the techniques and mechanisms of the present disclosure, instead of merely detecting whether a source is active or not, the system predicts instantaneous energy levels for each source in real time and monitors the amplitude of each source in a mixture continuously, frame by frame (with very short frame sizes), enabling much finer-grained control and analysis of the audio stream. As used herein, the term “energy estimate” refers to a quantitative measure representing the magnitude, intensity, or perceived loudness of a component source within a signal over a given time interval. The energy estimate may be based on root mean square (RMS), power, log-energy, perceptual loudness measures, or other functions of signal amplitude. In some embodiments, the energy estimate is computed from a representation of the signal. In other embodiments, the energy estimate is inferred directly by a trained model without explicitly computing a physical energy measure.

In some embodiments, the energy estimate may be computed using alternative formulations, including frequency-weighted energy, band-limited energy, perceptual loudness models, or learned energy representations produced by the model. In some embodiments, the energy estimate does not correspond to a physically computed energy metric but instead represents a learned proxy correlated with source intensity.

The techniques and mechanisms of the present disclosure provide more nuanced information than a simple on/off tag or event trigger. Using this new method, applications can respond dynamically to gradual increases or decreases in source energy (e.g., a singer's voice gradually getting louder), rather than waiting for discrete events. In addition, the system places emphasis on minimizing latency, achieving around 8.7 ms of algorithmic delay. This is a significant improvement compared to certain music source separation models that add 20-30 ms of latency (or more), as previously described above. The systems disclosed herein also provide advantages over event-based haptic systems that generally have coarser granularity by guaranteeing ultra-low-latency processing suitable for immediate interaction. Thus, the techniques and mechanisms of the present disclosure are improvements over current systems because of the ability to provide near-instantaneous feedback, which make real-time source signal energy estimations for augmented reality (AR) applications possible, as well as real-time collaboration and immersive experiences (e.g., VR performances, live instrument processing) due to the benefit from reduced audio “lag.”

In addition, because the systems disclosed herein focus on energy-level estimation rather than full-blown separation, the systems disclosed herein can also run efficiently on less powerful hardware (such as smartphones or AR/VR headsets) and maintain accurate per-source energy tracking without the complexity and processing cost of state-of-the-art separation networks. This means that the technology disclosed herein can be deployed widely and used in portable or embedded devices that have strict real-time requirements. In addition, the techniques and mechanisms of the present disclosure can also serve as a robust foundation for further tasks, such as selective mixing, personalized audio enhancements, or real-time audio-driven haptics, without incurring heavy latency penalties.

According to various embodiments, the techniques and mechanisms of the present disclosure include a method for estimating the energy of audio signals. The method involves receiving an audio signal sampled, e.g. at 44.1 kHz, and processing the sampled audio signal in segments. In some embodiments, the method calculates the energy of a distinct audio source within each segment. In some embodiments, the energy is represented as single floating-point values for each source, using a differentiable energy measure derived from the magnitude of the Short-Time Fourier Transform (STFT). This measure can reflect just the energy or also the perceived loudness depending on the application.

In some embodiments, the system processes the audio signal in a streaming manner and outputs energy estimates in real time with low latency. The latency may be less than 20 milliseconds, less than 10 milliseconds, or between 5 and 10 milliseconds. In some embodiments, the model maintains state information across successive input segments to enable continuous estimation.

In some embodiments, energy estimates may be generated at different temporal granularities, including per-frame, per-window, or aggregated over longer durations. The system may provide instantaneous energy estimates as well as smoothed, averaged, or accumulated energy values. In some embodiments, the energy estimates may be normalized relative to a total energy of the input signal or expressed as proportions among the component sources.

In one particular embodiment, the system can estimate the audio energy for 4 sources in parallel by processing input audio sampled at 44.1 kHz, segmenting it into segments of N values, and estimating the RMS energy of four distinct stems (in a specific case vocals, drums, bass, other). The system produces energy estimates at intervals of N/2. The deep-learning model, trained using back-propagation with clean audio recordings, underpins the process by learning how to isolate and measure the energy of each stem. This design provides a compact, low-latency way to capture essential audio characteristics, making it useful for further signal processing or integration into applications like haptic feedback generation or visual displays. In some embodiments, the number and type of component sources may vary and are not limited to a fixed set. The system may be configured to estimate energy for different source categories depending on the application.

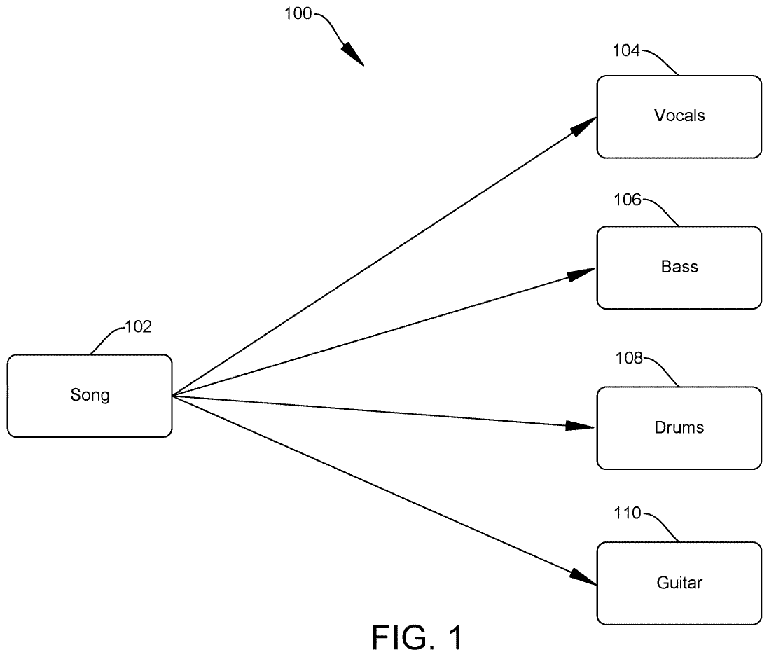

FIG. 1 is a representative view 100 of an example audio file decomposed into energy estimates for component parts, in accordance with embodiments of the present disclosure. View 100 shows an audio signal or file 102, comprised of a plurality of component parts. In some embodiments, audio signal or file 102 is any audio source or signal, such as a song. FIG. 1 illustrates audio signal 102 being broken into energy estimates for a plurality of sources 104, 106, 108, and 110. In the case of FIG. 1, song 102 the energy estimates for are broken down into four component parts, vocals 104, bass 106, drums 108, and guitar 110. However, in some other examples, the number of component parts can be more or less than four. While FIG. 1 shows audio file 102 being a song, in other examples, audio file 102 can be any other sound file, such as a live conversation, a single voice into a microphone, or a recording of a group of people's voices. In such examples, component parts 104-110 would then be each individual voices that make us the group.

In some embodiments, audio file 102 is an audio file input into the system. In some embodiments, the system outputs energy estimates for each source or component part 104-110. In some embodiments, each energy estimate may be used for downstream processing, such as visualization, audio mixing, control of external systems, or other applications, without requiring reconstruction of isolated audio tracks. Thus, techniques and mechanisms of the present disclosure take input in one format, e.g. an audio file, and convert it into output of a different format, e.g., energy estimates. In some embodiments, the output can be a single energy estimate of the entire input, e.g., of the entire audio file. In some embodiments, the input file can be a media file, or a digital file. In some embodiments, the input can also be an initial energy estimate input that then results in a plurality of separate energy estimates.

In some embodiments, the model directly predicts the energy values for each component source without generating an intermediate mask. In such embodiments, the model outputs a vector of scalar values corresponding to the energy of each component source for a given input segment. This direct prediction approach may reduce computational complexity and latency by eliminating intermediate processing steps.

In some embodiments, the machine learning model may comprise alternative architectures, including convolutional neural networks, transformer-based models, feedforward networks, or hybrid architectures combining temporal and spectral processing.

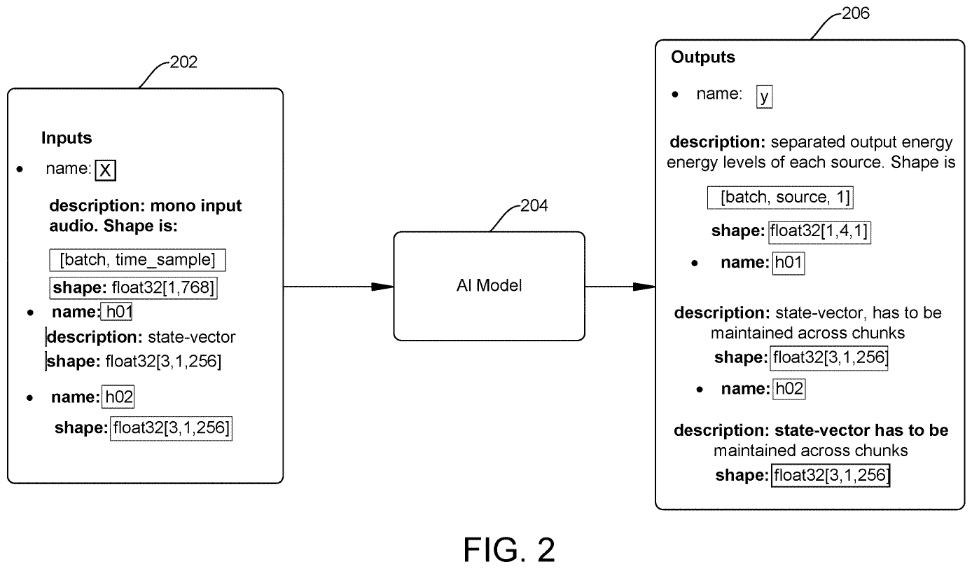

FIG. 2 illustrates example inputs and outputs for a model, in accordance with embodiments of the present disclosure. In some embodiments, the model is trained to predict the energy of multiple sources K given only the mixture x. In some embodiments, the ground truth separated sources (not produced by the model) can be denoted as Y=y₁, y₂, . . . yₖ, where each yᵢ is a separated target source and Y is the collection/tuple of all k sources. In some embodiments, an energy function E is applied to each source. In other words, E(Y) returns a vector of energies, one per source. Thus, the model now maps (directly from x to E(Y), without first outputting Y):

Ê(x)=NN_{θ}(x)≈E(Y)

Where E can be an arbitrary, differentiable function that represents the energy of a source, for example in the case of the spectral RMS:

$${E ( k )}_{R M S} = \sqrt{\frac{1}{N} {\sum }_{n} {\vert STFT ( {x}_{k} ) \vert}^{2}}$$

Where, x is the time-domain audio, STFT describes the Short-Term-Fourier-Transform, n is the current frame and N is the total number of frames. In some embodiments, the model is trained using pairs of mixture signals and corresponding energy vectors derived from ground truth source signals, enabling supervised learning of source-wise energy estimation.

As shown in FIG. 2, example AI model 204 has the following input 202 and output 206 specifications: Input 202 of model 204 is a single segment of N float values, which represents one chunk of mono audio samples. Output 206 is a single RMS energy value for each segment and source. According to various embodiments, it is important to note that the outputs depend on the energy of the input mixture. Thus, in such embodiments, a reduced input volume will also reduce the estimates of the stem energies. In some embodiments, the output energy estimates are dependent on the magnitude of the input mixture signal, such that variations in input signal amplitude proportionally affect the estimated energy values.

In some embodiments, model 204 is stateful and is configured to receive, in addition to the input audio segment, one or more state vectors that capture temporal context from prior processing steps. The state vectors may be initialized to default values and updated during successive inferences, enabling the model to maintain continuity across sequential input segments.

In some embodiments, the state vectors have predefined dimensions compatible with the internal architecture of the model, such as hidden states of a recurrent neural network, as illustrated in FIG. 2.

According to various embodiments, model 204 is trained using back-propagation on overlapping STFT frames. Thus, in such embodiments, the system implements the overlap and buffering. In such embodiments, that means the next input should be shifted by N/2 samples, and a new N size segment of audio is inputted. In some embodiments, it is important to use the optimal hop size of 1/2, as variances from the optimal hop size can have significant effect on the quality of energy estimations. In the example shown in FIG. 2, model 204 takes mono chunks as input, and outputs 4 source values for each chunk. In some embodiments, the processing of overlapping segments enables near real-time estimation of source-wise energy over a continuous audio stream. The outputs generated for successive segments may form a time-varying sequence of energy estimates corresponding to each component source.

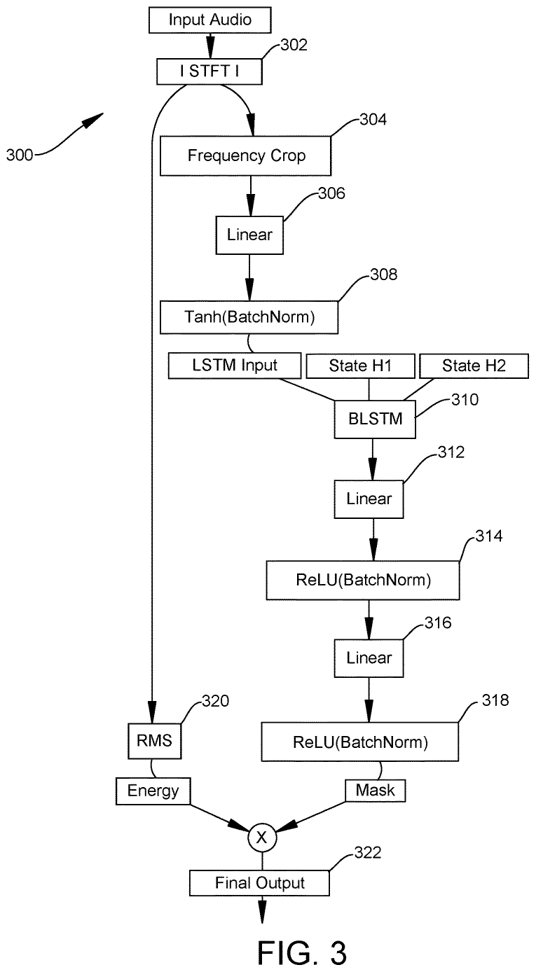

FIG. 3 illustrates an example model architecture 300, in accordance with embodiments of the present disclosure. In some embodiments, architecture 300 is based on a modified Open-Unmix (UMX) neural network adapted for source-wise energy estimation rather than waveform reconstruction. In some embodiments, model 300 includes a recurrent architecture, such as a bidirectional long short-term memory (BLSTM) network, to support frame-by-frame, low-latency processing. In contrast to conventional source separation architectures, the illustrated architecture is arranged to generate per-source mask values that are applied to an energy representation of the mixture signal. In some embodiments, the post-recurrent portion of the network includes one or more linear layers and corresponding activation and normalization operations that map latent features to non-negative mask values for the plurality of sources. For example, a final linear layer may be configured as Linear (in_features=hidden_size, out_features=nb_sources, bias=True) to perform regression and output source-specific values. In some embodiments, a ReLU activation is applied to prevent prediction of negative energy-related values. In some embodiments, a differentiable version of [symbol] E(k) [symbol] RMS is used to estimate energy values. With these modifications, example model 300 will now be described in further detail.

At step 302, the model receives a segment of input audio, such as an audio mixture having a length of N samples. As shown in FIG. 3, the input audio may be converted from the time domain into a transformed representation, for example by applying a Short-Time Fourier Transform (STFT). In some embodiments, the STFT uses an NFFT of 768 and a hop size of 384 to produce a magnitude spectrogram having dimensions T×F, where T corresponds to time frames and F corresponds to frequency bins (e.g., F=385). The spectrogram represents the time-frequency domain of the audio signal. In other embodiments, alternative transformations may be used, including mel-frequency representations, constant-Q transforms (CQT), wavelet transforms, or learned feature representations. In some embodiments, the model operates directly on raw time-domain audio without an explicit transformation.

In some embodiments, the input audio is processed using overlapping frames, for example with a hop size corresponding to a fraction (e.g., one-half) of the frame length, to enable continuous estimation with reduced boundary artifacts and improved temporal resolution. In some embodiments, the selection of frequency bins retained during the frequency cropping step may be determined empirically, based on task-specific constraints, or based on perceptual relevance of frequency bands for estimating source-wise energy.

At step 304, the transformed representation is frequency-cropped to reduce the number of frequency bins considered by the model. In some embodiments, the representation is limited to a selected subset of bins, denoted K, that is sufficient to characterize source-wise energy while reducing model size and computational cost. This reduction is beneficial, for example, where the input audio is sampled at 44.1 kHz but a reduced frequency range is sufficient for accurate estimation of source-wise energy.

In some embodiments, the frequency cropping operation may be fixed or dynamically configurable based on the application, such as selecting lower-frequency bands for speech-dominant signals or broader frequency ranges for music signals.

At step 306, the cropped representation is provided to a first linear (fully connected) layer that projects the frequency-domain input into a lower-dimensional latent space. In some embodiments, the layer reduces the dimensionality of the K frequency features to a hidden size, such as 256, to generate latent features for subsequent temporal modeling.

At step 308, the latent features are normalized, for example using batch normalization, and passed through a non-linear activation function, such as tanh, as illustrated in FIG. 3 by the “Tanh(BatchNorm)” stage. The resulting features are then reshaped, as appropriate, for recurrent processing and passed at step 310 to a multi-layer bidirectional LSTM (BLSTM). As shown in FIG. 3, the BLSTM may additionally receive state information, such as state vectors H1 and H2, which may store recurrent context across successive input segments in a streaming implementation. In some embodiments, a tanh activation function is used to constrain the outputs between [−1, 1]. In some embodiments, the state vectors H1 and H2 are optional and may be used to preserve temporal context across successive input segments in a streaming implementation. In other embodiments, the model may operate without maintaining recurrent state between segments.

At step 310, the transformed data is passed through a multi-layer bidirectional LSTM (BLSTM), which captures temporal dependencies across time frames and outputs updated latent features. In some embodiments, the BLSTM also outputs updated recurrent states (e.g., h1, h2), which may be reused in subsequent processing, such as in streaming implementations.

At step 312, the BLSTM output is provided to a subsequent linear layer for further feature transformation. In some embodiments, skip connections or residual feature combinations may also be used, although such variations are not required in every implementation.

At step 314, the output is passed through a second linear (fully connected) layer that reduces the dimensionality to a hidden size (e.g., hidden_size), followed by a normalization and activation stage, such as batch normalization and a rectified linear unit (ReLU), to introduce non-linearity and stabilize feature scaling.

At step 316, the transformed data is passed through a further linear layer configured to generate source-specific outputs. In some embodiments, the number of output units corresponds to the number of component sources.

At step 318, the output is passed through an activation and normalization stage, such as ReLU and batch normalization, to generate non-negative mask values for the respective sources, as illustrated by the “Mask” output in FIG. 3. In some embodiments, the masked output is reshaped back into the format (nb_frames, nb_samples, nb_sources) and permuted back to the shape (nb_samples, nb_sources, nb_frames) for further processing.

In some embodiments, the source-specific mask output is reshaped or reordered, as appropriate, to align the mask dimensions with the corresponding energy representation of the mixture signal for subsequent element-wise combination. The particular arrangement of dimensions may vary depending on implementation. In some embodiments, the mask values and the energy representation are aligned along corresponding dimensions, such as time frames and source indices, prior to combination. The combination may be performed using element-wise operations, such as multiplication, to produce per-source energy estimates.

At step 320, the model computes an energy representation of the input signal, such as a root mean square (RMS) value over time frames of the magnitude spectrogram. As shown in FIG. 3, this computation forms a parallel “Energy” branch that is combined with the mask branch at step 322. In some embodiments, the energy function is differentiable to enable gradient-based training.

At step 322, the source-specific mask values are applied to the energy representation of the mixture signal, for example by element-wise multiplication, to generate per-source energy estimates. As shown in FIG. 3, the mask branch and the RMS-derived energy branch are combined at the multiplication node X to produce the final output. In some embodiments, the resulting values correspond to estimated source-wise energy levels rather than reconstructed source waveforms. As illustrated in FIG. 3, the per-source mask outputs and the energy representation are combined at a multiplication node to produce the final per-source energy estimates. This combination enables estimation of source-wise energy without reconstructing individual source waveforms.

According to various embodiments, the final output of the forward pass comprises per-source energy estimates and, in some embodiments, one or more intermediate representations such as updated recurrent states for use in subsequent processing of later segments. The final output need not include separated audio signals or separated spectrograms.

The sequence shown in FIG. 3 is one example of a source-wise energy estimation architecture. In other embodiments, one or more stages may be omitted, replaced, reordered, or combined. For example, some systems may first perform source separation and then compute source energies in a separate stage; however, such approaches generally increase latency and computational cost relative to the illustrated architecture, which derives source-wise energy estimates without first reconstructing separated waveforms.

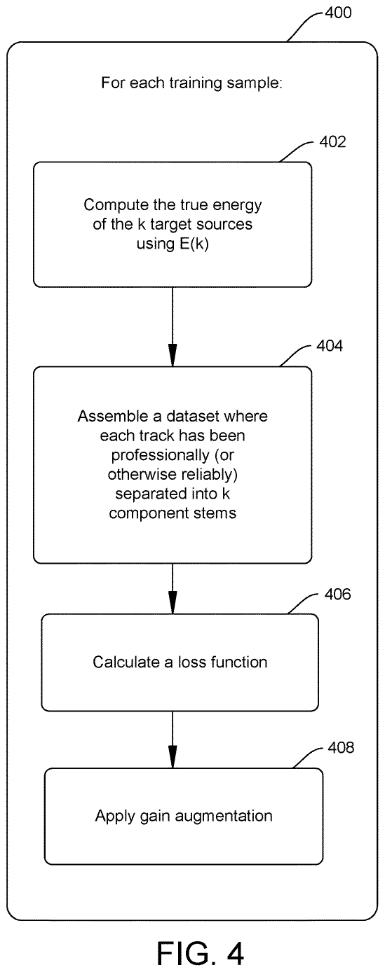

FIG. 3 illustrates one example inference architecture for source-wise energy estimation. FIG. 4 illustrates one example method 400 for training such a model, in accordance with embodiments of the present disclosure. In some embodiments, method 400 uses training samples that include a mixture signal and corresponding source signals from which target source-wise energy values are derived. Example method 400 is described below with reference to steps 402-408.

At step 402, for a given training sample, the system computes target energy values for the k source signals using an energy function E(⋅). In some embodiments, the target source signals are represented as Y=(y_1, y_2, . . . , y_k), and the target energy vector is computed as E(Y)=(E(y_1), E(y_2), . . . , E(y_k)). The energy function may be a differentiable measure, such as spectral RMS, so that the model can be trained using gradient-based optimization.

At step 404, the system assembles or accesses a training dataset in which each track includes a mixture signal and corresponding component stems. In some embodiments, each training sample includes: (a) a mixture signal x, such as a single-channel combination of the component sources; (b) ground-truth source signals Y=(y_1, y_2, . . . , y_k), such as vocals, drums, bass, other, dialogue, music, or effects; and (c) energy computations. In some embodiments, the single-channel combination of the component sources has all sources at a single predefined frequency, e.g., 44.1 kHz. In some embodiments, ground-truth sources Y includes individual sources that sum to the mixture and can be represented as Y=(y_1, \ldots, y_k). In some embodiments, the energy computations includes computing target energy E(y_i) for each ground-truth stem y_i using a chosen differentiable measure (e.g., spectral RMS). In such embodiments, this results in a reference energy vector E(Y) of size k. In some embodiments, the target energy values computed at step 402 are derived from these ground-truth source signals.

At step 406, the system calculates a loss function based on a comparison between the model output and the target energy values. In some embodiments, the loss function comprises a mean squared error between a predicted source-wise energy vector and the target energy vector E(Y).

At step 408, the system applies gain augmentation to improve robustness to variations in input amplitude. In some embodiments, gain augmentation is applied to the mixture signal, to one or more source signals, or both, to expose the model to a range of relative source levels during training.

In some embodiments, the model may be trained using synthetic mixtures, weak supervision, or self-supervised learning techniques. In some embodiments, target energy values may be derived from approximate or estimated source separations.

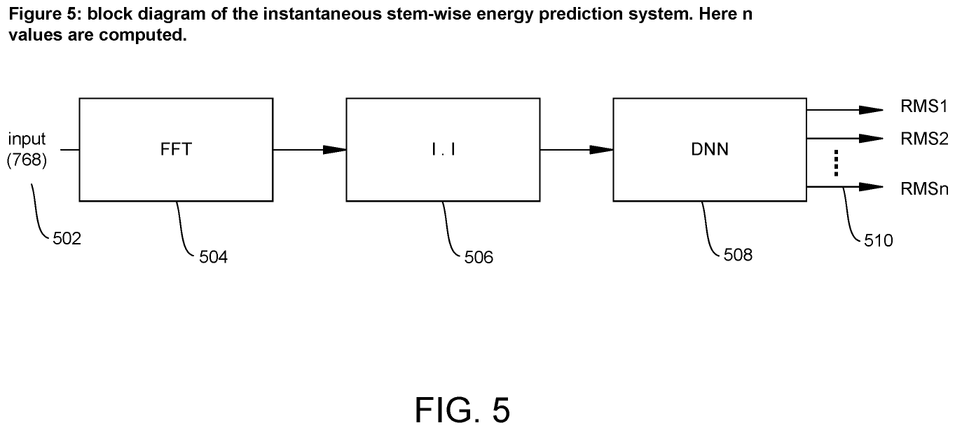

FIG. 5 illustrates a block diagram of an example instantaneous stem-wise energy prediction system, in accordance with embodiments of the present disclosure. As shown, input 502 is provided to a transform module 504, which generates a transformed representation of the input signal. In some embodiments, transform module 504 performs a frequency-domain transformation, such as a Fast Fourier Transform (FFT) or a Short-Time Fourier Transform (STFT), to produce a representation suitable for source-wise energy estimation. In some embodiments, where overlapping windows are used, transform module 504 may implement or form part of an STFT process.

In some embodiments, the transformed representation is provided to a deep neural network (DNN) module 508, which generates source-specific intermediate outputs, such as mask values or weighting values corresponding to a plurality of component sources. In parallel, an RMS module 506 computes one or more energy values from the input signal or from the transformed representation. For example, RMS module 506 may compute a sequence of RMS values over multiple frames or windows, represented in FIG. 5 as RMS1, RMS2, through RMSn. In some embodiments, n corresponds to a number of frames, windows, or other temporal subdivisions over which the energy representation is computed.

The output of RMS module 506 is then combined with the output of DNN module 508 to generate outputs 510. In some embodiments, the combination comprises applying the source-specific intermediate outputs generated by DNN module 508 to the RMS-derived energy values, such as by element-wise multiplication or weighting, to produce per-source energy estimates. Thus, FIG. 5 provides a system-level view of a pipeline in which an input signal is transformed, analyzed by a learned model, and combined with an energy representation to generate source-wise energy outputs.

In some embodiments, FIG. 5 is a higher-level functional representation of the architecture described in connection with FIG. 3. For example, transform module 504 may correspond to the transformation of input audio into a time-frequency representation, RMS module 506 may correspond to the energy branch described for step 320, and DNN module 508 may correspond to the learned mask-generation branch described for steps 306-318. The outputs 510 may correspond to per-source energy estimates generated without reconstructing separated source waveforms.

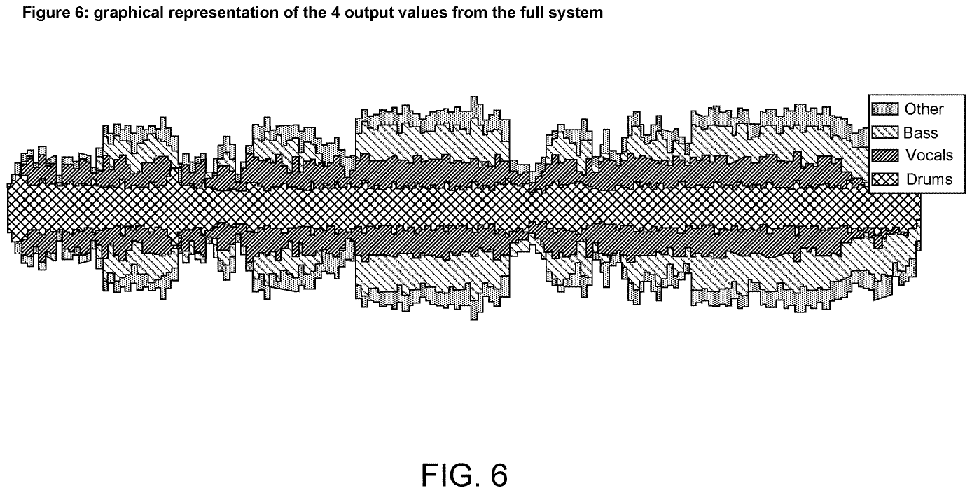

FIG. 6 illustrates an example graphical representation of source-wise energy estimation outputs, in accordance with embodiments of the present disclosure. In the illustrated example, the system produces separate output values corresponding to four component sources, labeled as drums, bass, vocals, and “other.” In some embodiments, each displayed output represents an estimated energy level for a corresponding source over a given segment, frame, or time interval of an input signal. Thus, FIG. 6 provides one example of how the outputs of the model may be represented as distinct source-wise energy estimates rather than reconstructed source waveforms. In some embodiments, the values illustrated in FIG. 6 correspond to outputs generated by the model architecture of FIG. 3 and/or the system-level pipeline of FIG. 5.

In some embodiments, the graphical representation of FIG. 6 may display relative magnitudes of the per-source energy estimates generated by the system for a given input segment, or may represent a sequence of such outputs over time. In some embodiments, the displayed values may be normalized, smoothed, averaged, or otherwise post-processed for visualization, while still reflecting the source-wise energy information estimated by the model. Although FIG. 6 illustrates four example component sources, the number and type of displayed outputs may vary depending on the application.

The systems and techniques presented provide many technical advantages and improvements to current technology. For example, the ability to calculate energy estimations for component parts from a single input signal without source separation represents a huge upgrade over current technology in terms of processing time and lag. This is very important for on-the-fly or in real-time processing of input signals.

The systems and techniques presented in this disclosure provide many real world applications and benefits. For example, the systems and techniques of the present disclosure allow for remixing of live or old recordings for which stems are not available. In addition, the systems and techniques of the present disclosure also allow for the creation of karaoke versions of songs without the need for the original stems. Further, the systems and techniques of the present disclosure also allow for the creation of movie soundtrack versions of songs without the need for the original stems. In addition, the systems and techniques of the present disclosure also allow for the isolation of particular instruments in order to facilitate further work such as transcription. The systems and techniques of the present disclosure also allow for the automatic identification of the instruments and vocals of a song without the need for explicit labeling. The systems and techniques of the present disclosure can also be helpful for remixing old or live recordings, allowing adjusting and readjusting of levels of certain instruments. The benefits of the present disclosure are not simply limited to just music. The systems and techniques of the present disclosure also allow for the isolation of distinct voices from a noisy background. It is also useful for picking out faint voices in recordings that are difficult to make out over other audio sources.

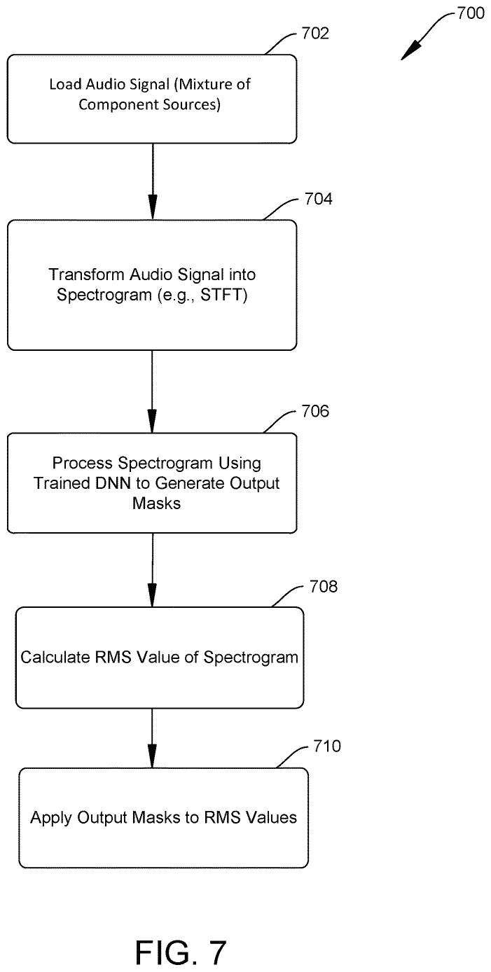

FIG. 7 illustrates an example method 700 for generating energy estimations of a plurality of component sources from a single input source, in accordance with embodiments of the present disclosure. In some embodiments, method 700 may be implemented using one or more processors executing instructions stored in memory, such as system 900 described herein. Method 700 corresponds to the operations described in connection with the claims and may be performed in real time or on stored audio data.

At step 702, an audio signal is loaded as the single input source. In some embodiments, the audio signal comprises a mixture of a plurality of component sources, such as vocals, drums, bass, and other audio elements. The audio signal may be obtained from a stored audio file, a live audio stream, or another audio input source. In some embodiments, the audio signal is sampled at a predefined sampling rate, such as 44.1 kHz, and may be processed in segments.

At step 704, the audio signal is transformed into an input spectrogram. In some embodiments, the spectrogram is generated using a Short-Time Fourier Transform (STFT), which converts the time-domain audio signal into a time-frequency representation. The resulting spectrogram may include magnitude values corresponding to frequency bins across time frames. This transformation enables the system to analyze spectral characteristics of the audio signal for subsequent processing.

At step 706, the input spectrogram is passed into a trained deep neural network (DNN), thereby producing an output mask. In some embodiments, the DNN is trained to output a mask for each component source in the plurality of component sources. The DNN may comprise a neural network architecture configured to process the spectrogram and generate per-source mask values that indicate the relative contribution of each component source within the mixture signal.

At step 708, a root mean square (RMS) value of the input spectrogram is calculated. In some embodiments, the RMS is computed over time frames of the magnitude spectrogram to determine an energy measure of the input signal. The RMS calculation provides a representation of the overall energy present in the audio signal over a given segment.

At step 710, the output mask generated by the DNN is applied to the calculated RMS value of the input spectrogram. In some embodiments, applying the mask produces a masked energy estimate for each component source. The mask selectively weights the RMS values such that the resulting masked values correspond to the estimated energy of each respective component source within the mixture.

In some embodiments, a masked energy estimate, or per-source energy estimate, is generated for each component source in the plurality of component sources. In some embodiments, each output represents the estimated energy level of a corresponding source. These outputs may be provided as scalar values per segment, time-varying energy signals, or other representations suitable for downstream processing.

In some embodiments, the masked energy estimate or per-source energy estimate is output in real time or near real time. In some embodiments, the method operates with a latency between approximately 6 and 8 milliseconds, enabling on-the-fly processing suitable for real-time applications such as audio visualization, live mixing, or interactive systems.

In some embodiments, steps 702-710 are repeated for successive segments of the audio signal in a streaming manner, enabling continuous estimation of component source energies over time. In some embodiments, the order of steps 702-710 may be modified, and one or more steps may be combined or omitted.

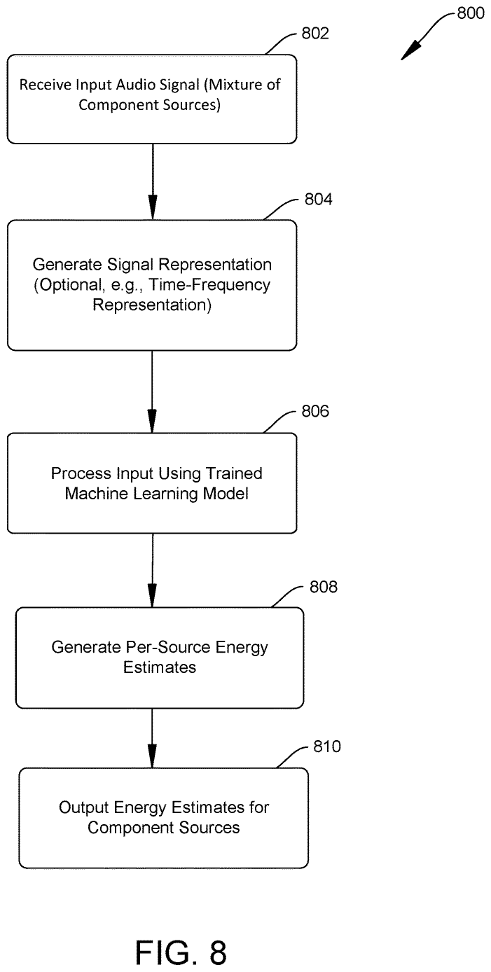

FIG. 8 illustrates an example method 800 for generating energy estimations of a plurality of component sources from an input signal, in accordance with embodiments of the present disclosure. In some embodiments, method 800 may be performed by one or more processors executing instructions stored in memory, such as the system described herein. Method 800 corresponds to the broader techniques described in the claims and enables estimation of per-source energy directly from a mixture signal without performing source separation.

At step 802, an input audio signal is received. In some embodiments, the input audio signal comprises a mixture of a plurality of component sources. The audio signal may be received from a stored audio file, a live audio stream, or another input source. In some embodiments, the audio signal is processed as a continuous stream or divided into segments for sequential processing.

At step 804, the input audio signal is optionally transformed into a representation suitable for processing by a machine learning model. In some embodiments, the representation comprises a time-frequency representation, such as a spectrogram generated using a Short-Time Fourier Transform (STFT). In other embodiments, alternative representations may be used, including mel-frequency representations, wavelet transforms, or learned feature representations. In some embodiments, the model operates directly on the raw time-domain audio signal without an explicit transformation.

At step 806, the input audio signal or the representation thereof is processed using a trained machine learning model. In some embodiments, the machine learning model is configured to output, for each of the plurality of component sources, a respective energy estimate corresponding to that component source. The model may comprise a neural network, including but not limited to recurrent neural networks, convolutional neural networks, transformer-based architectures, or hybrid models.

At step 808, the machine learning model generates a respective energy estimate for each component source in the plurality of component sources. In some embodiments, the energy estimates are produced directly by the model as scalar values or vectors corresponding to each source. In other embodiments, the energy estimates may be derived from intermediate outputs of the model. In some embodiments, the respective energy estimates are generated without performing source separation of the input audio signal into individual component source waveforms. In some embodiments, the method avoids reconstructing isolated audio signals for each component source, thereby reducing computational complexity and latency.

At step 810, the respective energy estimates for the plurality of component sources are output. In some embodiments, the output may be provided as per-segment scalar values, time-varying energy signals, or other representations suitable for downstream processing, including visualization, audio processing, or control of external systems. In some embodiments, the method outputs the respective energy estimates in real time or near real time. In some embodiments, the system operates with a latency below a predetermined threshold, such as less than 20 milliseconds, less than 10 milliseconds, or within a range of approximately 5 to 10 milliseconds.

In some embodiments, steps 802-810 are repeated for successive segments of the input audio signal, enabling continuous estimation of energy levels for each component source in a streaming manner. In some embodiments, one or more steps of method 800 may be omitted, reordered, or combined without departing from the scope of the present disclosure.

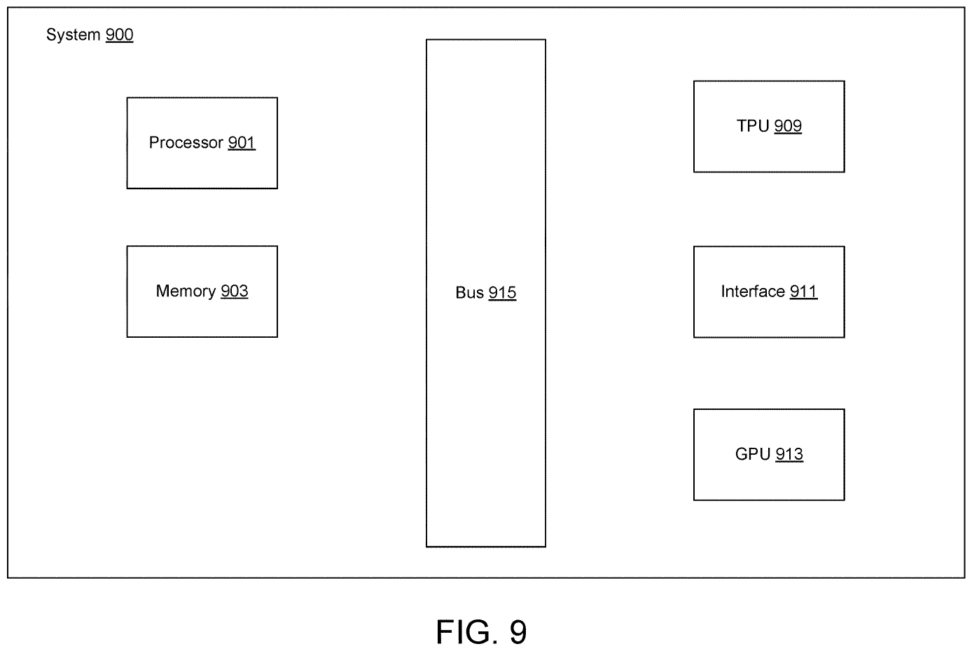

FIG. 9 illustrates one example of a system 900, in accordance with one or more embodiments. According to particular embodiments, a system 900, suitable for implementing particular embodiments of the present disclosure, includes a processor 901, a memory 903, an interface 911, and a bus 915 (e.g., a PCI bus or other interconnection fabric) and operates as a streaming server. In some embodiments, when acting under the control of appropriate software or firmware, the processor 901 is responsible for processing inputs through various computational layers and algorithms, such as down sample layers and up sample layers. In other embodiments, the processor is responsible for updating the parameters of each computational layer within the deep learning model. Various specially configured devices can also be used in place of a processor 901 or in addition to processor 901. The interface 911 is typically configured to send and receive data packets or data segments over a network. In addition, in some embodiments, system 900 can also include a specialized processor TPU 909, in order to facilitate machine learning, and/or a specialized processor GPU 913 for implementing a cloud multi-GPU machine.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 900 uses memory 903 to store data and program instructions for operations including training a neural network, such as method 200. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

The foregoing description of various aspects and examples have been presented for purposes of illustration and description. It is not intended to be exhaustive nor to limit the disclosure to the forms described. The aspects(s) illustrated in the figures can, in some instances, be understood to be shown to scale for illustrative purposes. Numerous modifications are possible in light of the above teachings, including a combination of the abovementioned aspects. Some of those modifications have been discussed and others will be understood by those skilled in the art. The various aspects were chosen and described in order to best illustrate the principles of the present disclosure and various aspects as are suited to the particular use contemplated. The scope of the present disclosure is, of course, not limited to the examples or aspects set forth herein, but can be employed in any number of applications and equivalent devices by those of ordinary skill in the art. Rather, it is hereby intended the scope be defined by the claims appended hereto.

What is claimed is:

1. A method for generating energy estimations, the method comprising:
receiving an input audio signal comprising a mixture of a plurality of component sources;
processing the input audio signal using a trained machine learning model configured to output, for each of the plurality of component sources, a respective energy estimate of the component source, wherein the respective energy estimates are generated without performing source separation of the input audio signal into individual component source waveforms; and
outputting the respective energy estimates.

2. The method of claim 1, further comprising:
transforming the input audio signal into a time-frequency representation, wherein processing the input audio signal comprises processing the time-frequency representation using the trained machine learning model.

3. The method of claim 2, wherein the time-frequency representation comprises a spectrogram generated using a Short-Time Fourier Transform (STFT).

4. The method of claim 2, wherein the time-frequency representation comprises magnitude values of frequency bins over time frames.

5. The method of claim 1, wherein the trained machine learning model comprises a neural network.

6. The method of claim 5, wherein the neural network comprises a recurrent neural network.

7. The method of claim 1, wherein the respective energy estimates are generated in real time with a latency below a predetermined threshold.

8. A system for generating energy estimations, the system comprising:
a processor; and
memory storing instructions to execute a method, the method comprising:
receiving an input audio signal comprising a mixture of a plurality of component sources;
processing the input audio signal using a trained machine learning model configured to output, for each of the plurality of component sources, a respective energy estimate of the component source, wherein the respective energy estimates are generated without performing source separation of the input audio signal into individual component source waveforms; and
outputting the respective energy estimates.

9. The system of claim 8, wherein the method further comprises:
transforming the input audio signal into a time-frequency representation, wherein processing the input audio signal comprises processing the time-frequency representation using the trained machine learning model.

10. The system of claim 9, wherein the time-frequency representation comprises a spectrogram generated using a Short-Time Fourier Transform (STFT).

11. The system of claim 9, wherein the time-frequency representation comprises magnitude values of frequency bins over time frames.

12. The system of claim 8, wherein the trained machine learning model comprises a neural network.

13. The system of claim 12, wherein the neural network comprises a recurrent neural network.

14. The system of claim 8, wherein the respective energy estimates are generated in real time with a latency below a predetermined threshold.

15. A non-transitory computer readable medium storing instructions to be executed by a processor, the instructions comprising:
receiving an input audio signal comprising a mixture of a plurality of component sources;
processing the input audio signal using a trained machine learning model configured to output, for each of the plurality of component sources, a respective energy estimate of the component source, wherein the respective energy estimates are generated without performing source separation of the input audio signal into individual component source waveforms; and
outputting the respective energy estimates.

16. The non-transitory computer-readable medium of claim 15, further comprising:
transforming the input audio signal into a time-frequency representation, wherein processing the input audio signal comprises processing the time-frequency representation using the trained machine learning model.

17. The non-transitory computer-readable medium of claim 16, wherein the time-frequency representation comprises a spectrogram generated using a Short-Time Fourier Transform (STFT).

18. The non-transitory computer-readable medium of claim 16, wherein the time-frequency representation comprises magnitude values of frequency bins over time frames.

19. The non-transitory computer-readable medium of claim 15, wherein the trained machine learning model comprises a neural network.

20. The non-transitory computer-readable medium of claim 19, wherein the neural network comprises a recurrent neural network.
